(19) United States
(12) Patent Application Publication
(10) Pub. No.: US 2011/0027510 A1
(43) Pub. Date: Feb. 3, 2011

(54) POLYAMIDE CLAY COMPOSITE COMPOSITION AND FUEL TRANSPORT TUBE USING THE SAME

(75) Inventors: Choon Soo Lee, Seoul (KR); Min Hee Lee, Hwaseong (KR); Joung Sook Hong, Suwon (KR); Jin Young Huh, Gunpo (KR); Doo Han Ha, Anyang (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); CHEIL INDUSTRIES INC.

(21) Appl. No.: 12/620,188

(22) Filed: Nov. 17, 2009

(30) Foreign Application Priority Data
Jul. 30, 2009 (KR) 10-2009-0070150

(51) Int. Cl. B32B 1/08; C08K 3/34

(52) U.S. Cl. 428/35.7; 524/445; 524/447

(57) ABSTRACT

A polyamide clay composite composition including (A) 100 parts by weight of a base resin containing (A-1) 30 to 99.9% by weight of a polyamide resin and (A-2) 0.1 to 70% by weight of a polyolefin resin, (B) 3 to 30 parts by weight of an olefin oligomer with respect to 100 parts by weight of the basin resin, and (C) 0.5 to 5 parts by weight of a layered clay compound, and a fuel transport tube prepared using the same are provided.

### CROSS-REFERENCE TO RELATED APPLICATION

This application claims under 35 U.S.C. §119(a) the benefit of Korean Patent Application No. 10-2009-0070150 filed Jul. 30, 2009, the entire contents of which are incorporated herein by reference.

### BACKGROUND

(a) Technical Field

The present disclosure relates, in general, to a polyamide clay composite composition. More particularly, the present invention relates to a polyamide clay composite composition and a fuel transport tube prepared using the same.

(b) Background Art

In accordance with the strengthening of international regulations on environmental pollution, the international regulations on exhaust gas emissions from vehicles, such as those in Europe-EURO IV, U.S.A.-PZEV, Japan-EURO IV, and China-EURO III, have been considerably strengthened, and thus improvement of fuel barrier properties is required for various vehicle systems such as a fuel tank, a fuel tube, etc.

Moreover, with an increase in the development and use of biofuels, which have higher volatility than that of other existing fuels (in particular, due to the content of ethanol), there is a necessity for developing materials having excellent chemical resistance and low permeability.

Since conventional resins have poor barrier properties to fossil fuels and biofuels at a temperature above room temperature, a fuel transport tube, for example, should preferably have a multilayer structure of more than three layers to meet the international environmental standards.

Korean Patent Publication No. 10-2009-0053585, incorporated by reference in its entirety herein, discloses a polyolefin/nylon resin blend composition having barrier properties comprising: 55 to 90% by weight of a high density polyethylene resin; 5 to 40% by weight of a polyamide resin selected from the group consisting of nylon 11, nylon 12, and combinations thereof; and 1 to 20% by weight of a copolymer, as a compatibilizer, of high density polyethylene and maleic anhydride or acrylic acid. However, this resin composition has poor gasoline resistance and dispersion of nanoclay, and thus it cannot improve the fuel barrier properties. In particular, the resin composition is not highly desirable to be used as a material for manufacturing a fuel transport tube which is to be exposed to fuel for a long time.

Korean Patent Publication No. 10-2007-0028174, incorporated by reference in its entirety herein, discloses a nanocomposite composition having barrier properties comprising: 100 parts by weight of a poly-olefin resin; 1 to 60 parts by weight of a barrier composite comprising a mixture of polyamide and polyolefin and a layered clay compound; and 0.5 to 30 parts by weight of a compatibilizer. However, this nanocomposite composition has a low heat deflection temperature and poor mechanical properties and gasoline resistance, which should be improved for the formation of the fuel transport tube for transporting fuel at a temperature above room temperature, and thus is not suitable to be used as a material for manufacturing the fuel transport tube.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a polyamide clay composite composition having excellent chemical resistance and capable of forming a suitably uniform nano-dispersed structure. In preferred embodiments, the present invention provides a fuel transport tube prepared using the polyamide clay composite composition and having suitably improved barrier properties of organic solvents and fuels and excellent properties such as, but not limited to, moldability, impact strength, etc.

In one preferred embodiment, the present invention provides a polyamide clay composite composition including: (A) 100 parts by weight of a base resin containing (A-1) 30 to 99.9% by weight of a polyamide resin and (A-2) 0.1 to 70% by weight of a polyolefin resin; (B) 3 to 30 parts by weight of an olefin oligomer with respect to 100 parts by weight of the basin resin; and (C) 0.5 to 5 parts by weight of a layered clay compound.

In another preferred embodiment, the present invention provides a fuel transport tube suitably prepared using the polyamide clay composite composition.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram of a fuel oil tank mounted with a sample for measuring fuel barrier properties;

FIG. 2 is an X-ray diffraction (XRD) image comparing interlayer distances of layered clay compounds of Examples 1 to 3 and Comparative Example 1;

FIG. 3 is an electron microscope image showing clay layers dispersed in a sample prepared using a polyamide clay composite composition in accordance with Example 2; and

FIG. 4 is an electron microscope image showing clay layers dispersed in a sample prepared using a polyamide clay composite composition in accordance with Comparative Example 1.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

In a first aspect, the present invention provides a polyamide clay composite composition comprising (A) 100 parts by weight of a base resin containing a polyamide resin and a polyolefin resin (B) an olefin oligomer; and (C) 0.5 to 5 parts by weight of a layered clay compound.

In one embodiment, the polyamide clay composite composition of claim 12, wherein the base resin contains (A-1) 30 to 99.9% by weight of the polyamide resin and (A-2) 0.1 to 70% by weight of the polyolefin resin.

In another embodiment, the olefin oligomer comprises 3 to 30 parts by weight of an olefin oligomer with respect to 100 parts by weight of the basin resin.

The invention also provides a fuel transport tube prepared using the polyamide clay composite composition of any one of the above aspects.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

A polyamide clay composite composition according to preferred embodiments of the present invention is described in more detail below.

(A) Base Resin

In certain preferred embodiments, a base resin for preparing the polyamide clay composite composition of the present invention comprises a polyamide resin and a polyolefin resin.

(A-1) Polyamide Resin

The polyamide resin in accordance with an exemplary embodiment of the present invention has an amino group in its main chain and is suitably prepared by polymerizing an amino acid, a lactam or diamine, and a dicarboxylic acid.

Examples of the amino acid include, but are not limited to, 6-aminocaproic acid, 11-aminoundecanoic acid, 12-aminododecanoic acid, and para-aminomethylbenzoic acid. Examples of the lactam include, but are not limited to, ε-caprolactam and ω-laurolactam. Examples of the diamine include, but are not limited to, aliphatic, alicyclic or aromatic diamines such as tetramethylenediamine, hexamethylenediamine, 2-methylpentamethylenediamine, nonamethylenediamine, undecamethylenediamine, dodecamethylenediamine, 2,2,4-trimethylhexamethylenediamine, 5-methylnonamethylenediamine, metaxylenediamine, paraxylenediamine, 1-3bis(aminomethyl)cyclohexane, 1,4-bis(aminomethyl)cyclohexane, 1-amino-3-aminomethyl-3,5,5-trimethylcyclohexane, bis(4-aminocyclohexyl)methane, bis(3-methyl-4-aminocyclohexyl)methane, bis(aminopropyl)piperazine, and aminoethylpiperazine. Examples of the dicarboxylic acid include, but are not limited to, aliphatic, alicyclic or aromatic dicarboxylic acid such as adipic acid, suberic acid, azelaic acid, sebacic acid, dodecane-2-acid, terephthalic acid, isophthalic acid, 2-chloroterephthalic acid, 2-methylterephthalic acid, 5-methylisophthalic acid, 5-sodiumsulfoisophthalic acid, 2,6-naphthalenedicarboxylic acid, hexahydroterephthalic acid, and hexahydroisophthalic acid. In certain preferred embodiments, a polyamide homopolymer or copolymer derived from these raw materials may be used solely or as a mixture thereof.

Preferably, examples of the polyamide resin include, but are not limited to, polycaprolactam(polyamide 6), poly(11-aminoundecanoic acid) (polyamide 11), polylauryllactam(polyamide 12), poly-4,6-tetramethylenediamine adipic acid (polyamide 4,6), polyhexamethylene adipic acid (polyamide 6,6), polyhexaethylene azelamide (polyamide 6,9), polyhexaethylene sebacamide(polyamide 6,10), polyhexaethylene dodecanediamide (polyamide 6,12), polyamide 6/6,10 copolymer, polyamide 6/6,6 copolymer, polyamide 6/12 copolymer, and combinations thereof. Particularly, the polyamide resin may be selected from the group consisting of polyamide 4,6, poly(11-aminoundecanoic acid) (polyamide 11), and combinations thereof. More particularly, in further preferred embodiments, the polyamide resin may be poly(11-aminoundecanoic acid) (polyamide 11). According to further preferred embodiments of the invention, the poly(11-aminoundecanoic acid)(polyamide 11) suitably provides excellent gasoline resistance and low wettability at a temperature above room temperature.

According to further preferred embodiments of the present invention, the polyamide resin should have a melting point of more than 185° and a relative viscosity of more than 2 (measured at 25° C. after adding 1% by weight of a polyamide resin to m-cresol as an organic solvent). Preferably, in this case, the polyamide clay composite composition has suitably excellent mechanical properties and heat resistance.

In further preferred embodiments, the polyamide resin may include at least one type of polyamide with a glass transition temperature of more than 50° without limitations.

According to certain exemplary embodiments of the invention, the polyamide resin may be suitably contained in an amount of 30 to 99% by weight with respect to the total amount of the base resin containing polyamide resin and polyolefin resin. Particularly, the polyamide resin may be suitably contained in an amount of 50 to 99% by weight. In this case, the polyamide clay composite composition has excellent chemical resistance and fuel barrier properties at a suitable temperature (e.g., at 60° C.) above room temperature.

(A-2) Polyolefin Resin

The polyolefin resin in accordance with an exemplary embodiment of the present invention may be selected from the group consisting of, but not limited only to, high density polyethylene (HDPE) with a density range of 0.94 to 0.965, linear low density polyethylene (LLDPE) with a density range of 0.91 to 0.94, polypropylene, ethylene-vinylalcohol copolymer, ethylene-propylene copolymer, and combinations thereof.

Preferably, the polyolefin resin may be suitably contained in an amount of 0.1 to 70% by weight with respect to the total amount of the base resin containing polyamide resin and polyolefin resin. Preferably, the polyolefin resin may be contained in an amount of 0.1 to 50% by weight. In this case, the polyamide clay composite composition has excellent fuel barrier properties.

(B) Olefin Oligomer

According to certain preferred embodiments of the present invention, olefin oligomer contained in the base resin has no suitable compatibility with the polyamide resin in the polyamide clay composite composition. Accordingly, in order to improve the compatibility between polyamide resin and polyolefin resin of the base resin, the olefin oligomer is preferably added to the polyamide clay composite composition.

According to further preferred embodiments, the olefin oligomer may be selected from the group consisting of, but not limited only to, olefin-acrylate oligomer, olefin-maleic anhydride modified oligomer, and combinations thereof. Preferably, when the olefin-maleic anhydride modified oligomer is used, it is possible to effectively improve the compatibility between polyolefin resin and polyamide resin.

In certain preferred embodiments, the olefin-acrylate oligomer may be selected from the group consisting of, but not limited only to, ethylene methyl-acrylate oligomer, ethylene ethyl-acrylate oligomer, ethylene butyl-acrylate oligomer, ethylene vinyl-acrylate oligomer, and combinations thereof.

In other preferred embodiments, the olefin-maleic anhydride modified oligomer may be selected from the group consisting of, but not limited only to, ethylene butene-maleic anhydride modified oligomer, ethylene octene-maleic anhydride modified oligomer, ethylene propylene-maleic anhydride modified oligomer, and combinations thereof.

Preferably, the olefin-maleic anhydride modified oligomer may comprise 0.1 to 30 parts by weight of maleic anhydride branches with respect to 100 parts by weight of the main chain. Accordingly, the compatibility between polyamide and polyolefin and their basic properties such as impact strength are suitably improved. Preferably, if the amount of maleic anhydride branches is less than 0.1 parts by weight, it is suitably difficult to improve the compatibility between polyamide and polyolefin of the base resin, whereas if it is more than 30 parts by weight, an oligomer phase is formed to suitably reduce the compatibility, crystallinity, and fuel barrier properties.

In other certain preferred embodiments, the olefin oligomer may be suitably contained in an amount of 3 to 30 parts by weight with respect to 100 parts by weight of the base resin. Preferably, the compatibility between polyamide resin and polyolefin resin is excellent and, since the olefin oligomer does not suitably form its phase, it is possible to suitably obtain a substantially uniform dispersion and excellent properties such as fuel barrier properties.

(C) Layered Clay Compound

According to further preferred embodiments of the present invention, the polyamide clay composite compound comprises a layered clay compound, which may be selected from the group consisting of, but not limited only to, montmorillonite, bentonite, kaolinite, mica, hectorite, fluorohectorite, saponite, beidellite, nontronite, stevensite, vermiculite, halloysite, volkonskoite, suconite, magadiite, and kenyaite.

Preferably, the layered clay compound has hydrophilic surface characteristics, in which the hydrophilic group is suitably substituted with an organic compound to suitably improve the compatibility with the organic compound. The organic compound which can be suitably substituted with a hydrophilic group may be a compound having a functional group selected from the group consisting of, but not limited only to, quaternary ammonium, maleate, succinate, acrylate, benzylic hydrogen, and oxazoline. In further preferred embodiments, the layered clay compound substituted with quaternary ammonium imparts suitable compatibility and dispersion properties to the polyamide resin, thus enabling the molded articles produced using the polyamide clay composite composition to suitably ensure the fuel barrier properties.

According to preferred embodiments of the present invention, the layered clay compound is suitably contained in the polyamide clay composite composition in an amount of 0.5 to 5 parts by weight with respect to 100 parts by weight of the base resin. Preferably, when more than 5 parts by weight of the layered clay compound is suitably contained in the base resin, the layer exfoliation and dispersion properties of the layered clay compound become suitably difficult to obtain, thus deteriorating the properties of the composite. Preferably, when the layered clay compound is suitably contained in an amount of 0.5 to 4.5 parts by weight, the fuel barrier properties, the mechanical properties such as tensile strength, and the thermal stability are excellent.

In further preferred embodiments, the polyamide clay composite composition of the present invention may further comprise the following resin stabilizer.

(D) Resin Stabilizer

According to other preferred embodiments of the present invention, the resin stabilizer serves to suitably stabilize the polyamide resin and polyolefin resin contained in the polyamide clay composite composition when molded articles are produced using the polyamide clay composite composition by, for example, extrusion or injection, thus suitably preventing these resins from being decomposed (e.g., thermal decomposition) or from suitably reacting with each other. Preferably, with the addition of such a resin stabilizer, the polyamide resin or polyolefin resin in the polyamide clay composite composition can suitably exhibit its characteristics, and the thermal stability and moldability of the polyamide clay composite composition can be greatly improved.

According to further preferred embodiments of the present invention, any resin stabilizer, which is well known in the art, may be used without particular limitations. For example, the resin stabilizer may be selected from the group consisting of, but not limited to, phosphoric acid, triphenylphosphite, trimethylphosphite, triisodecylphosphite, tri-(2,4,-di-t-butylphenyl)phosphite, 3,5-di-t-butyl-hydroxybenzylphosphonic acid, tetrakis propionate methane, and combinations thereof.

Preferably, the resin stabilizer may be suitably contained in an amount of 0.01 to 10 parts by weight with respect to 100 parts by weight of the base resin. Preferably, the resin stabilizer may be suitably contained in an amount of 0.01 to 5 parts by weight. Accordingly, in certain exemplary embodiments, the thermal stability and moldability of the polyamide clay composite composition are excellent.

According to further preferred embodiments of the present invention, the polyamide clay composite composition can be prepared by suitably mixing the above-described components, and the molded articles can be produced by melt-extruding the thus prepared polyamide clay composite composition.

Preferably, the polyamide clay composite composition exhibits excellent fuel barrier properties such as a permeation rate of 2.54 g/m²·hr when immersed in 20% ethanol and fuel at 60° C. Further, since the polyamide clay composite composition preferably has excellent properties such as moldability as well as the fuel barrier properties, it can be used to suitably prepare a high volatile fuel transport tube or tank, and further it can be used in various applications such as a vehicle fuel system.

According to another exemplary embodiment of the present invention, a fuel transport tube prepared using the above-described polyamide clay composite composition is provided.

In certain preferred embodiments, the fuel transport tube has a structure that preferably contains the base resin containing polyamide resin and polyolefin resin, the olefin oligomer suitably dispersed in the base resin, the layered clay compound, and the resin stabilizer. Preferably, as the fuel transport tube, a molded article is suitably produced using the polyamide clay composite composition in accordance with another exemplary embodiment of the present invention to have excellent fuel barrier properties. In further preferred embodiments, this molded article plastic article has excellent properties such as moldability, thermal stability, and chemical resistance.

Exemplary embodiments of the present invention will be described in more detail with reference to the following Examples. However, these Examples are only for purposes of illustration and are not intended to limit the present invention.

According to preferred exemplary embodiments, detailed specifications of (A) a base resin containing (A-1) a polyamide resin and (A-2) a polyolefin resin, (B) an olefin oligomer, (C) a layered clay compound, and (D) a resin stabilizer, which will be used in the following Examples and Comparative Examples, are as follows:

(A1) Polyamide Resin

(A-11) Polyamide Resin 11

In one exemplary embodiment, polyamide resin 11 (Arkema, BESNO TL) having a viscosity of more than 10,000 [Pa·s] (100[1/s]) at 220° was used.

(A-12) Polyamide Resin 6

In another exemplary embodiment, polyamide 6 (Zig Sheng, TP4407) having a viscosity of 100 to 1,000 [Pa·s] (100[1/s]) at 220° was used.

(A-2) Polyolefin Resin

In a further exemplary embodiment, linear low density polyethylene (Samsung Total 4222F) having an average molecular weight (Mw) of more than 1,000 g/mol was used.

(B) Olefin Oligomer

In another exemplary embodiment, ethylene-butene-maleic anhydride oligomer (DuPont, Fusabond MN493D) was used.

(C) Layered Clay Compound

In further exemplary embodiment, layered clay compound (Nanocor, I.44P) having an average length of 0.5 to 1 μm and an interlayer distance of less than 5 nm, in which Na⁺ ions are substituted with NH₄⁺ and (CH₂)n (n>15), was used.

(D) Resin Stabilizer

In another exemplary embodiment, IRGANOX B 1171 (Ciba Geigy), which is a mixture of IRGANOX 1098 (hindered phenolic antioxidant) and IRGAFOS 168 (organo-phosphite) in a ratio of 1:1, was used.

### Examples 1 to 4 & Comparative Examples 1 to 4

### Preparation of Polyamide Clay Composite Compositions

In one exemplary embodiment, polyamide clay composite compositions in accordance with Examples 1 to 4 and Comparative Examples 1 to 4 were preferably prepared by suitably mixing the above-described constituent components in the mixing ratios shown in the following Table 1:

TABLE 1

| | | Example | | | | Comparative Example | | | |
|---|---|---|---|---|---|---|---|---|---|
| Components | | 1 | 2 | 3 | 4 | 1 | 2 | 3 | 4 |
| (A) | (A11) Polyamide resin 11 | 75 | 95 | — | 75 | 100 | 75 | 25 | 75 |
| Base resin | (A12) Polyamide resin 6 | — | — | 70 | — | — | — | — | — |
| (% by weight) | (A2) Polyolefin resin | 25 | 5 | 30 | 25 | — | 25 | 75 | 25 |

| | | | | | | | | |
|---|---|---|---|---|---|---|---|---|
| (B) Olefin oligomer (parts by weight) | 16 | 10 | 11 | 16 | 16 | — | 16 | 16 |
| (C) Layered clay compound (parts by | 4 | 3 | 5 | 4 | 4 | 4 | 4 | 10 |
| weight) | | | | | | | | |
| (D) Resin stabilizer (parts by weight) | 0.2 | 0.2 | 0.2 | — | 0.2 | 0.2 | 0.2 | 0.2 |

[Preparation of Samples for Property Measurement]

Preferably, the polyamide clay composite compositions according to Examples 1 to 4 and Comparative Examples 1 to 4 were suitably melt-extruded in a biaxial melt extruder heated to 250° and formed into pellets.

In further preferred embodiments, the thus formed pellets were dried at 100° for four hours, ASTM samples were suitably prepared using the dried pellets in a screw-type injector heated to 250° C. to evaluate the mechanical properties such as flexural strength, tensile strength, and impact strength, and discs having a diameter of 10 mm were injection-molded from the pellets with thicknesses of 1 mm and 2 mm, respectively, to suitably evaluate the fuel barrier properties.

### Test Example 1

### Measurement of Mechanical Properties

In another exemplary embodiment, tensile strengths of the samples of Examples 1 to 4 and Comparative Examples 1 to 4 prepared in the same manner as above were suitably measured in accordance with ASTM D638, U.S. standard test method for tensile strength of plastics. Preferably, flexural strengths of the samples of Examples 1 to 4 and Comparative Examples 1 to 4 prepared in the same manner as above were suitably measured in accordance with ASTM D790, U.S Standard Test Method for flexural strength of plastics. And, impact strengths of the samples of Examples 1 to 4 and Comparative Examples 1 to 4 prepared in the same manner as above were suitably measured in accordance with ASTM D256, U.S Standard Test Method for impact strength of plastics. The thus measured mechanical strengths are shown in the following Table 2.

### Test Example 2

### Measurement of Fuel Barrier Properties

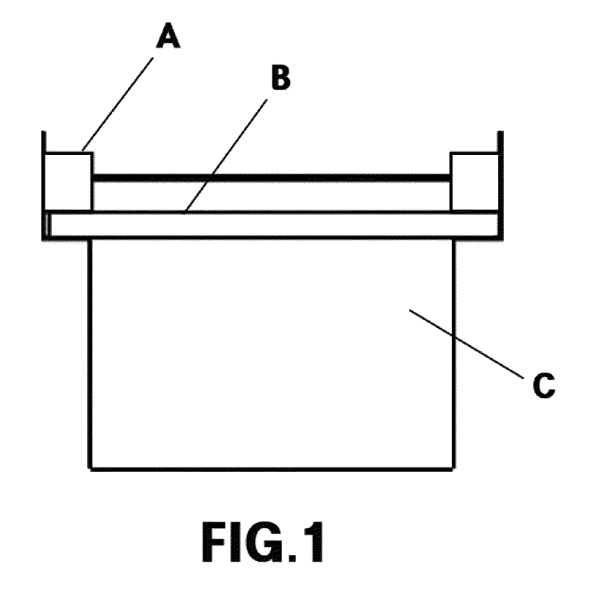

In another exemplary embodiment, first, a fuel oil tank mounted with a sample for measuring fuel barrier properties is shown in FIG. 1, in which 20% ethanol/gasoline was used as a fuel. Each of the samples (B of FIG. 1) for measuring fuel barrier properties according to Examples 1 to 4 and Comparative Examples 1 to 4 was suitably mounted in the fuel oil tank (FIG. 1) to measure the change in weight at 60° C. with the lapse of time. Preferably, the edge of the tank was fixed using a jig (A of FIG. 1) to prevent volatilized fuel (C of FIG. 1) from leaking, and the results are shown in the following Table 2.

### Test Example 3

### Measurement of Moldability

In another exemplary embodiment, moldability of each of the samples of Examples 1 to 4 and Comparative Examples 1 to 4 prepared in the same manner as above was measured. Since the samples are molded by plastic forming process such as co-extrusion using an annular die, the viscosity and elasticity of molten resin are important factors in the molding. In order to compare the viscosity and elasticity of the samples according to the Examples and Comparative Examples, the moldability of the samples was suitably determined by the sheet molding process using a T-die having a width of 15 cm. Preferably, sheets having a thickness of 100 um and a length of 100 cm were suitably molded under constant extruder processing conditions (extruder temperature/T-die temperature: 230° C.). The moldability of each sheet is shown in the following Table 2.

### Test Example 4

### Measurement of Heat Deflection Temperature

In another exemplary embodiment, the heat deflection temperatures of the samples of Examples 1 to 4 and Comparative Examples 1 to 4 prepared in the same manner as above were suitably measured in accordance with ASTM D648, U.S Standard Test Method for deflection temperature, and the thus measured heat deflection temperatures are shown in the following Table 2.

### Test Example 5

### Measurement of Dispersion Properties

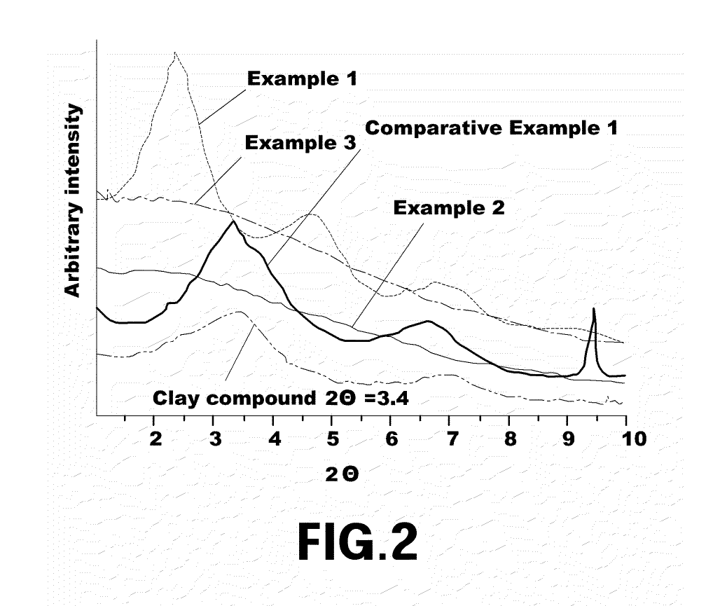

In another exemplary embodiment, changes in the layer structure (layer intercalation/exfoliation) and dispersion properties in the samples of Examples 1 to 4 and Comparative Examples of 1 to 4 were suitably measured using a transmission electron microscope (TEM) and an X-ray diffraction (XRD) (measurement conditions: wavelength of Cu K-α1, 40 mA, at 40 mV), and the results are shown in FIGS. 2 to 4.

TABLE 2

| | | Measurement of Mechanical Strengths | | | | | |
|---|---|---|---|---|---|---|---|
| | | Tensile | Flexural | | | | Heat |
| | | Strength | Strength | Impact | | Fuel | Deflection |
| | | [kgf/cm², | [kgf/cm², | Strength | | Permeability | Temp. |
| Classification | | 50 mm/min] | 2.8 mm/min] | [kgf · cm/cm] | Moldability | [g/m² · hr] | [° C.] |
| Example | 1 | 410 | 247 | 90 | ◯ | 2.0 | 113 |
| | 2 | 510 | 490 | 56 | ◯ | 2.7 | 120 |
| | 3 | 480 | 510 | 82 | ◯ | 5.0 | 115 |
| | 4 | 430 | 255 | 92 | ◯ | 2.0 | 112 |
| Comparative | 1 | 568 | 570 | 12 | X | 15.0 | 110 |
| Example | 2 | 450 | 540 | 8 | X | 25.0 | 105 |
| | 3 | 290 | 150 | 20 | X | 35.0 | 60 |
| | 4 | 400 | 350 | 15 | X | 30.5 | 70 |

It can be seen from Table 2 that the polyamide clay composite compositions prepared by melt-mixing the base resin containing polyamide resin and polyolefin resin with the polyolefin oligomer and the layered clay compound in the mixing ratios according to an exemplary embodiment of the present invention had excellent fuel barrier properties and mechanical properties.

Further, the samples of Examples 1 to 4 had excellent fuel barrier properties and mechanical properties compared to those of Comparative Example 2 which contained no olefin oligomer and those of Comparative Example 4 in which the content of layered clay compound exceeded the range of the present invention. The excellent fuel barrier properties and mechanical properties result from the morphology of the layered clay compound having excellent dispersion properties and interlayer intercalation/exfoliation and the base resin having suitably high compatibility between polyamide resin and polyolefin resin due to the olefin oligomer.

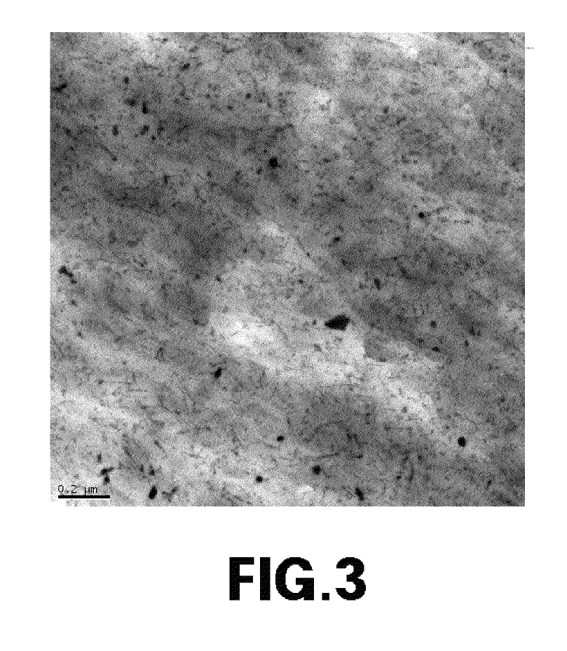

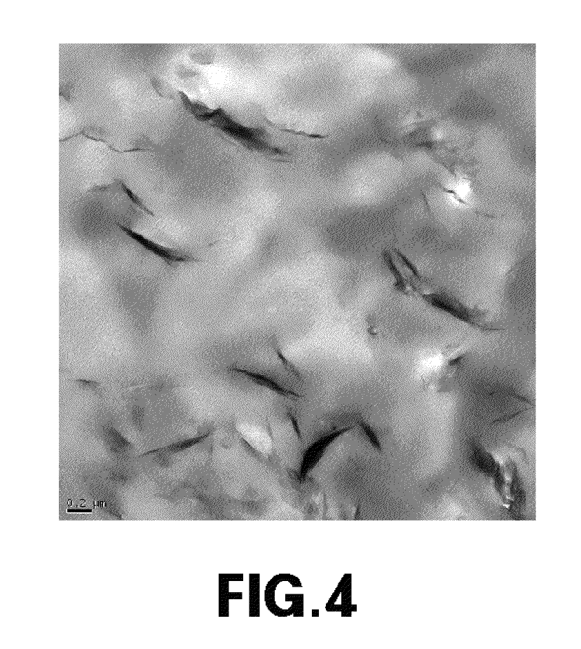

In another further embodiment and as shown in FIG. 2, FIG. 2 is an X-ray diffraction (XRD) image comparing interlayer distances of layered clay compounds of Examples 1 to 3 and Comparative Example 1. It can be seen in FIG. 2 that the layer structures of the layered clay compounds of Examples 1 to 3 disappeared. On the contrary, the interlayer distance of the layered clay compound of Comparative Example 3 was kept at 2.5 nm at it was. When the layer structures of the layered clay compounds were observed by an electron microscope, it could be seen that the layer structure of the layered clay compound of Example 2 was broken and the clay layers were uniformly dispersed (FIG. 3). However, it could be seen that the interlayer distance of several hundred nanometers was kept as it was in the layered clay compound of Comparative Example 1 (FIG. 4).

Accordingly, the samples of Examples 1 to 4 had excellent fuel barrier properties and mechanical properties such as, for example, tensile strength and impact strength due to the efficient interlayer dispersion of the layered clay compound and the compatibility between polyamide resin and polyolefin resin.

As described above, since the polyamide clay composite composition in accordance with an exemplary embodiment of the present invention is preferably prepared using the layered clay compound, it can be used to suitably prepare a fuel transport tube having excellent fuel barrier properties, dispersion properties, and mechanical properties such as tensile strength, impact strength, and moldability.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A polyamide clay composite composition comprising:
(A) 100 parts by weight of a base resin containing (A-1) 30 to 99.9% by weight of a polyamide resin and (A-2) 0.1 to 70% by weight of a polyolefin resin;
(B) 3 to 30 parts by weight of an olefin oligomer with respect to 100 parts by weight of the basin resin; and
(C) 0.5 to 5 parts by weight of a layered clay compound.

2. The polyamide clay composite composition of claim 1, wherein the polyamide resin is contained in an amount of 50 to 99.9% by weight and the polyolefin resin is contained in an amount of 0.1 to 50% by weight.

3. The polyamide clay composite composition of claim 1, wherein the polyamide resin is selected from the group consisting of polycaprolactam(polyamide 6), poly(11-aminoundecanoic acid) (polyamide 11), polylauryllactam (polyamide 12), poly-4,6-tetramethylenediamine adipic acid (polyamide 4,6), polyhexamethylene adipic acid (polyamide 6,6), polyhexaethylene azelamide (polyamide 6,9), polyhexaethylene sebacamide(polyamide 6,10), polyhexaethylene dodecanediamide (polyamide 6,12), polyamide 6/6,10 copolymer, polyamide 6/6,6 copolymer, polyamide 6/12 copolymer, and combinations thereof.

4. The polyamide clay composite composition of claim 1, wherein the polyolefin resin is selected from the group consisting of: high density polyethylene, linear low density polyethylene, polypropylene, ethylene-vinylalcohol copolymer, ethylene-propylene copolymer, and combinations thereof.

5. The polyamide clay composite composition of claim 1, wherein the olefin oligomer is selected from the group consisting of: olefin-acrylate oligomer, olefin-maleic anhydride modified oligomer, and combinations thereof.

6. The polyamide clay composite composition of claim 5, wherein the olefin-acrylate oligomer is selected from the group consisting of: ethylene methyl-acrylate oligomer, ethylene ethyl-acrylate oligomer, ethylene butyl-acrylate oligomer, ethylene vinyl-acrylate oligomer, and combinations thereof.

7. The polyamide clay composite composition of claim 5, wherein the olefin-maleic anhydride modified oligomer is selected from the group consisting of: ethylene butene-maleic anhydride modified oligomer, ethylene octene-maleic anhydride modified oligomer, ethylene propylene-maleic anhydride modified oligomer, and combinations thereof.

8. The polyamide clay composite composition of claim 5, wherein the olefin-maleic anhydride modified oligomer comprises 0.1 to 30 parts by weight of maleic anhydride branches with respect to 100 parts by weight of its main chain.

9. The polyamide clay composite composition of claim 1, wherein the layered clay compound is selected from the group consisting of: montmorillonite, bentonite, kaolinite, mica, hectorite, fluorohectorite, saponite, beidellite, nontronite, stevensite, vermiculite, halloysite, volkonskoite, suconite, magadiite, and kenyaite.

10. The polyamide clay composite composition of claim 1, further comprising (D) 0.01 to 10 parts by weight of a resin stabilizer with respect to 100 parts by weight of the base resin.

11. A fuel transport tube prepared using the polyamide clay composite composition of claim 1.

12. A polyamide clay composite composition comprising:
(A) 100 parts by weight of a base resin containing a polyamide resin and a polyolefin resin;
(B) an olefin oligomer; and
(C) 0.5 to 5 parts by weight of a layered clay compound.

13. The polyamide clay composite composition of claim 12, wherein the base resin contains (A-1) 30 to 99.9% by weight of the polyamide resin and (A-2) 0.1 to 70% by weight of the polyolefin resin.

14. The polyamide clay composite composition of claim 12, wherein the olefin oligomer comprises 3 to 30 parts by weight of an olefin oligomer with respect to 100 parts by weight of the basin resin.

15. A fuel transport tube prepared using the polyamide clay composite composition of claim 12.
